(19) United States
(12) Patent Application Publication
(10) Pub. No.: US 2022/0402410 A1
(43) Pub. Date: Dec. 22, 2022

(54) SYSTEMS, APPARATUSES, AND METHODS FOR A CONVERTIBLE CHILD CAR SEAT

(71) Applicant: Graco Children's Products, Inc., Atlanta, GA (US)

(72) Inventors: JOONHO NA, Brookhaven,, GA (US); DOUGLAS JIN KIM, Marietta, GA (US); NICHOLAS HENRY REAVES, Marietta, GA (US)

(73) Assignee: Graco Children's Products, Inc., Atlanta, GA (US)

(21) Appl. No.: 17/807,697

(22) Filed: Jun. 17, 2022

Related U.S. Application Data
(60) Provisional application No. 63/212,130, filed on Jun. 18, 2021.

(51) Int. Cl. B60N 2/28

(52) U.S. Cl. CPC B60N 2/2806; B60N 2/2812

(57) ABSTRACT

An apparatus for seating a child in a vehicle may include a seat, a backrest coupled to the seat at an angle, and an upper support movably coupled to the backrest. The upper support is configured to move relative to the backrest between an expanded configuration and a collapsed configuration. The upper support may be non-load bearing. The apparatus may further include a rethread harness system. A method of adjusting a children's car seat may include removing a locking component from a first receiving loop. The method may further include sliding a non-load bearing upper support along a backrest of the children's car seat. The method may further include inserting the locking component into a second receiving loop.

### CROSS-REFERENCE TO RELATED APPLICATIONS

The present disclosure claims the benefit of U.S. Provisional No. 63/212,130, filed on Jun. 18, 2021, which is incorporated by reference in its entirety.

### TECHNICAL FIELD

The present disclosure is generally directed to children's car seats, and more particularly to systems, apparatuses, and methods for a convertible child car seat.

### BACKGROUND

Certain children's car seats are well-known in the art. A typical children's car seat can be designed to provide an infant, toddler, or child with a safe and comfortable enclosure while traveling in an automobile. In certain instances, support for the child can be increased through a headrest and/or other similar devices.

However, such conventional children's car seats may not be convenient to use because conventional children's car seats may be relatively bulky. Even if such a problem has been recognized, many existing children's car seats utilize traditional headrests that are load-bearing from the harness, which is not optimal because traditional headrests cost more money, are structurally riskier due to their load-bearing nature, and are larger. Further, increasing the seat back angle of the children's car seat results in a reduced car seat depth and increased front seat leg room, but the child is disposed in a more upright position, which puts the child at higher risk of having an airway blockage. Thus, the seat in front of the children's car seat may have to be moved forward, which results in reduced front seat leg room. This may result in discomfort for the person in the front seat or may even make the front seat unusable. An alternative choice would be to have a conventional convertible children's car seat disposed in the center of a back seat of the automobile, which can still result in a less optimal fit to the seat due to limited lower anchor availability and/or a geometry of the seat.

### SUMMARY

The present disclosure is generally directed to children's car seats, and more particularly to systems, apparatuses, and methods for a convertible child car seat. In embodiments, the present disclosure describes an apparatus for seating a child in a vehicle. The apparatus may include a seat, a backrest coupled to the seat at an angle, and an upper support movably coupled to the backrest. The upper support is configured to move relative to the backrest between an expanded configuration and a collapsed configuration. In some embodiments, the upper support is not load-bearing.

In embodiments, the present disclosure describes an apparatus for seating a child in a vehicle. The apparatus may include a seat, a backrest coupled to the seat at an angle, a rethread harness system, and an upper support coupled to the backrest and slidable relative to the backrest between an expanded configuration and a collapsed configuration. In some embodiments, the upper support is not load-bearing.

In embodiments, the present disclosure describes a method of adjusting a children's car seat. The method may include removing a locking component from a first receiving loop. The method may further include sliding a non-load bearing upper support along a backrest of the children's car seat. The method may further include inserting the locking component into a second receiving loop.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 is a conceptual side view of a children's car seat in a collapsed configuration.

FIG. 2 is a conceptual side view of a children's car seat in an expanded configuration.

FIG. 3 is a conceptual perspective view of an apparatus for seating a child in a vehicle, in a collapsed configuration.

FIG. 4 is a conceptual side view of the apparatus of FIG. 3.

FIG. 5 is a conceptual partial front view of the apparatus of FIG. 3 transitioning from the collapsed configuration to an expanded configuration.

FIG. 6 is a conceptual perspective view of the apparatus of FIG. 3 in the expanded configuration.

FIG. 7 is a conceptual a side view of the apparatus of FIG. 3 in the expanded configuration.

The present disclosure provides a more detailed and specific description with reference to the accompanying drawings. The drawings and specific descriptions of the drawings, as well as any specific or other embodiments discussed, are intended to be read in conjunction with the entirety of this disclosure.

### DETAILED DESCRIPTION

Example embodiments will now be described more fully hereinafter with reference to the accompanying drawings, in which example embodiments are shown. The concepts disclosed herein may, however, be embodied in many different forms and should not be construed as limited to the example embodiments set forth herein; rather, these embodiments are provided so that this disclosure will be thorough and complete, and will fully convey the scope of the concepts to those skilled in the art. Like numbers refer to like, but not necessarily the same or identical elements throughout.

The present disclosure relates to, among other things, systems, apparatuses, and methods for a convertible children's car seat. In embodiments, systems and apparatuses for a convertible children's car seat are provided. In other embodiment, methods for changing a convertible children's car seat between a compact configuration and an expanded configuration are provided.

Car seats may include movable components. For example, an upper support of a car seat may be movable relative to a seat of the car seat. However, an upper support that is load bearing, for example, load bearing with respect to a harness, may exhibit reduced adjustability, or the load may interfere with positioning or adjustment. Car seats according to the present disclosure may include upper supports that are non-load bearing, for example, being free of a load exerted by a harness.

Providing a non-load bearing movable upper support may provide further or alternative advantages, for example, providing extra legroom to front row occupant when installed in a rear facing configuration. In a forward facing configuration, the seat may provide a saved height, for example, reducing or avoiding interference with vehicle headrest or vehicle C pillar. Car seats according to the present disclosure may be shipped in a contracted position, allowing for a smaller packaging size.

In embodiments, the present disclosure describes an apparatus for seating a child in a vehicle. The apparatus may include a seat, a backrest coupled to the seat at an angle, and an upper support movably coupled to the backrest. The upper support is configured to move relative to the backrest between an expanded configuration and a collapsed configuration. In some embodiments, the upper support is not load-bearing.

In embodiments, the present disclosure describes an apparatus for seating a child in a vehicle. The apparatus may include a seat, a backrest coupled to the seat at an angle, a rethread harness system, and an upper support coupled to the backrest and slidable relative to the backrest between an expanded configuration and a collapsed configuration. In some embodiments, the upper support is not load-bearing.

In embodiments, the present disclosure describes a method of adjusting a children's car seat. The method may include removing a locking component from a first receiving loop. The method may further include sliding a non-load bearing upper support along a backrest of the children's car seat. The method may further include inserting the locking component into a second receiving loop. The sliding may include sliding a vertical tab of the upper support along a vertical slot of the backrest. The sliding may include sliding respective support wings of the upper support along respective backrest wings of the backrest. Sliding the upper support along the backrest may increase or decrease a height of the children's car seat.

Certain relationships between features of the children's car seat are described herein using the term “substantially” or “substantially equal.” As used herein, the terms “substantially” and “substantially equal” indicate that the equal relationship is not a strict relationship and does not exclude functionally similar variations therefrom. Unless context or the description indicates otherwise, the use of the term “substantially” or “substantially equal” in connection with two or more described dimensions indicates that the equal relationship between the dimensions includes variation that, using mathematical and industrial principles accepted in the art (e.g., rounding, measurement or other systematic errors, manufacturing tolerances, etc.), would not vary the least significant digit of the dimensions. As used herein, the term “substantially parallel” indicates that the parallel relationship is not a strict relationship and does not exclude functionally similar variations therefrom. As used herein, the term “substantially orthogonal” or “substantially perpendicular” indicates that the orthogonal relationship is not a strict relationship and does not exclude functionally similar variations therefrom.

In embodiments, a convertible children's car seat may include a seat and a backrest. In some instances, a slidable component may be included to allow for extension of an upper support of the children's car seat to an expanded configuration and collapsing of the upper support of the children's car seat to a collapsed configuration.

In embodiments, the children's car seat may further include a locking feature to enable the slidable component to be locked into either the expanded configuration or the collapsed configuration.

In embodiments, the children's car seat may further include a rethread harness system, such that the slidable component is not load-bearing.

In some embodiments, the upper support of the children's car seat is a headrest. In other embodiments, the upper support may support the back of an occupant in addition to or instead of the head.

In embodiments, the children's car seat may include an upper support with an actuator to control the slidable component. In other embodiments, the children's car seat may include an upper support configured for manual adjustment of the slidable component.

In some embodiments, the slidable component may be detachable and may be manually adjustable and/or installable.

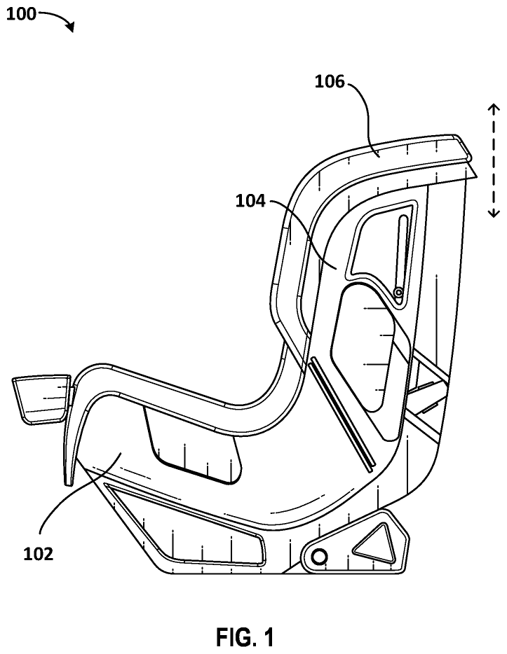

FIG. 1 is a conceptual side view of a children's car seat 100 in a collapsed configuration. The children's car seat 100 may include a seat 102 and a backrest 104. In the collapsed configuration, the children's car seat 100 may be at its minimum size, for example, at a minimum height. In particular, the backrest 104 is coupled to an upper support 106, which is at a collapsed position relative to the backrest 104. The upper support 106 may be moved vertically relative to the backrest 104 (and to the seat 102) from the collapsed configuration of FIG. 1 to expand the overall height of the car seat 100.

The seat 102, the backrest 104, or the upper support 106 may be made of any material that is suitable for a children's car seat. The seat 102, the backrest 104, or the upper support may also be of any shape that is suitable for a children's car seat.

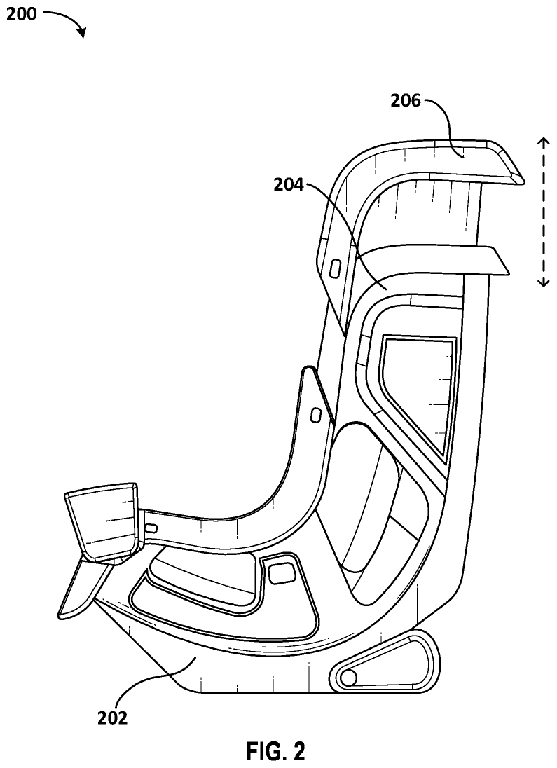

FIG. 2 is a conceptual side view of a children's car seat 200 in an expanded configuration. The car seat 200 is somewhat different in shape and geometry than the car seat 100. However, like the children's car seat 100, the children's car seat 200 includes a seat 202, a backrest 204, and an upper support 206. In the expanded configuration shown in FIG. 2, the upper support 206 is vertically extended to a maximum height relative to the backrest 204 (and the seat 202), thus increasing the overall height of the children's car seat 200. The upper support 206 may be lowered relative to the backrest 204, to move the seat from the expanded configuration of FIG. 2 to a collapsed configuration (similar to the collapsed configuration shown in FIG. 1). In particular, the upper support 206 may be lowered vertically relative to the backrest 104 (and to the seat 102) from the expanded configuration of FIG. 2 to reduce the overall height of the car seat 200.

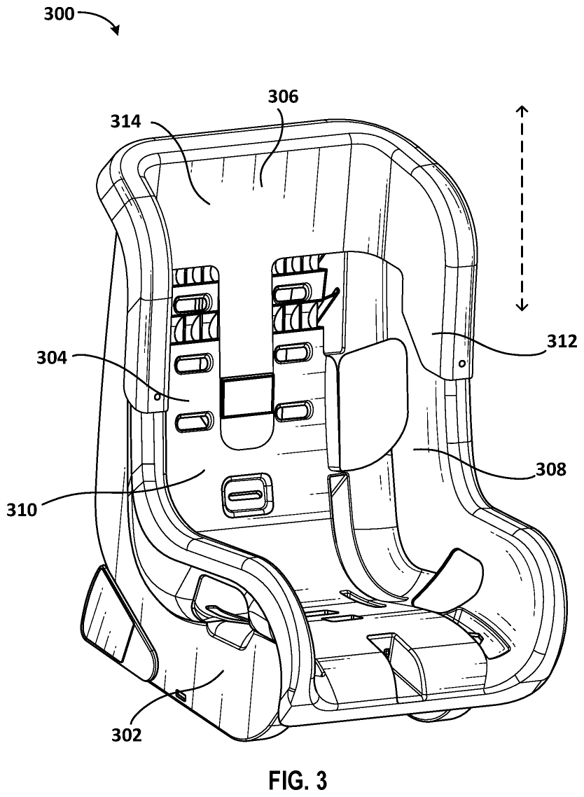

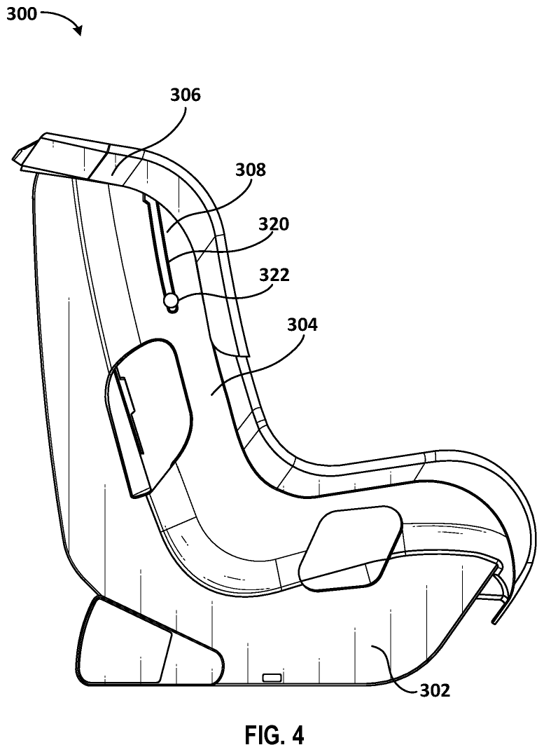

FIG. 3 is a conceptual perspective view of an apparatus 300 for seating a child in a vehicle, in a collapsed configuration. FIG. 4 is a conceptual side view of the apparatus 300 of FIG. 3.

The apparatus 300 forms a car seat, having a somewhat different in shape and geometry than the car seats 100 and 200. However, like the children's car seats 100 and 200, the children's car seat 300 includes a seat 302, a backrest 304, and an upper support 306. The seat 302, the backrest 304, or the upper support 306 may be made of any material that is suitable for a children's car seat. The seat 302, the backrest 304, or the upper support 306 may also be of any shape that is suitable for a children's car seat. As shown in FIGS. 3 and 4, the backrest 304 may integrally extend from the seat 302. For example, the backrest 304 and the seat 302 may be formed in a unitary single piece.

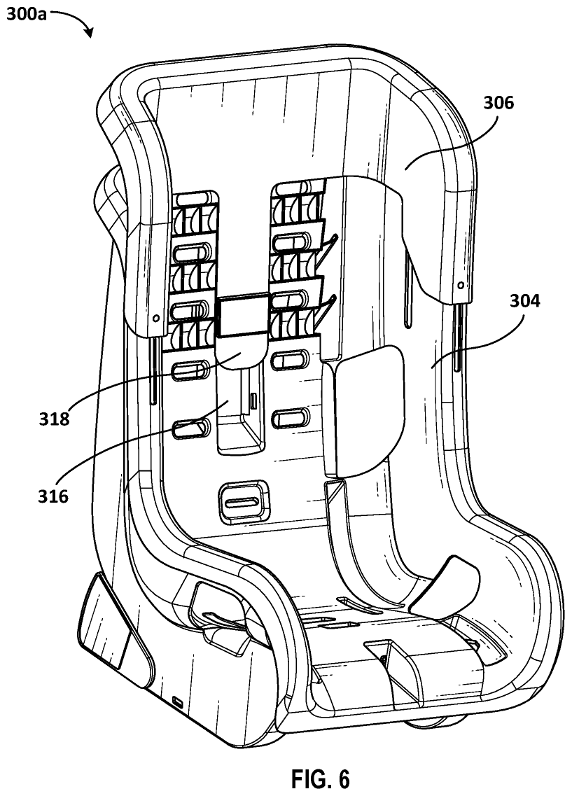

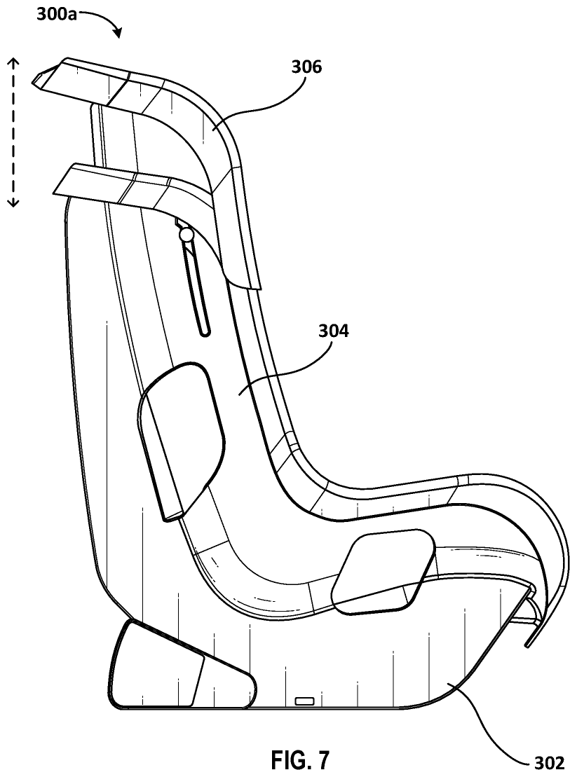

The backrest 304 may be coupled to the seat 302 at an angle. The upper support 306 is movably coupled to the backrest 304. The upper support 306 is configured to move relative to the backrest 304 between an expanded configuration (shown in FIGS. 6 and 7) and a collapsed configuration (shown in FIGS. 3 and 4). In some embodiments, the upper support 306 is not load-bearing. For example, no load may be exerted on the upper support 306 by a harness or a locking mechanism for securing the apparatus 100 to a vehicle.

In embodiments, the apparatus 300 further includes a locking component to lock the upper support 306 in one or both of the expanded configuration or the collapsed configuration, for example, relative to the backrest 304 or the seat 302. The locking component may include a vertical tab of the upper support 306 engaged in a vertical slot of the backrest 304, and having a detent, or a plurality of detents therebetween, with each detent defining a predetermined relative position between the backrest 304 and the upper support 306.

In embodiments, the backrest 304 defines a pair of backrest wings 308 extending from a backrest back 310. Likewise, the upper support 306 may define a pair of support wings 312 extending from a support back 314. The support wings 312 may be aligned with the backrest wings 308. In embodiments, the support wings 312 may define channels within which the backrest wings 308 may be slidingly received, so that the backrest wings 308 may slide in contact along the support wings 312. Providing such sliding contact between the backrest wings 308 and the support wings 312 may reduce or avoid a horizontal relative movement, or shuddering or jarring, between the backrest 304 and the support 306, during relative vertical movement therebetween.

Thus, the upper support 306 may be configured to slide between the expanded configuration and the collapsed configuration. For example, respective wings 312 of the upper support 306 may be configured to slide along respective wings 308 of the backrest 304.

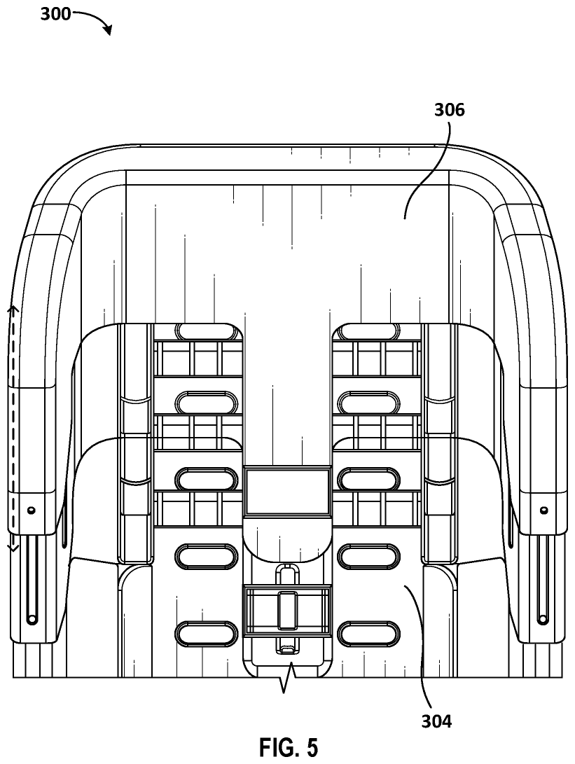

FIG. 5 is a conceptual partial front view of the apparatus 300 of FIG. 3 transitioning from the collapsed configuration to an expanded configuration. As shown in FIG. 5, a user may pull the upper support 306 to cause it to slide or move upward relative to the backrest 304 (away from the seat 302), ultimately increasing an overall height of the apparatus 300. Vice versa, the user may push the upper support 306 to cause it to slide or move downward relative to the backrest 304 (toward the seat 302), ultimately reducing the overall height of the apparatus 300.

FIG. 6 is a conceptual perspective view of the apparatus 300 of FIG. 3 in an expanded configuration 300a. FIG. 7 is a conceptual a side view of the apparatus of FIG. 3 in the expanded configuration 300a.

The upper support 306, in the expanded configuration 300a, may extend to a predetermined height vertically beyond the backrest 304. The predetermined height may include one or more intermediate heights, and a maximum height. For example, the upper support 306 may be retainable in one or more intermediate positions between a minimum height and a maximum height relative to the backrest 304.

In embodiments, the backrest 304 may defines a vertical slot 316, and the upper support 306 may defines a vertical tab 318 movable along the vertical slot 316. In some such embodiments, the back 310 of the backrest 304 may define the vertical slot 316, and the back 314 of the upper support may define the vertical tab 318. The vertical tab 318 may define a protrusion receivable within one or more detents defined alone the vertical slot 316, such that the upper support 306 may be stably held at one or more intermediate positions relative to the backrest 304.

In embodiments, each backrest wing of the pair of backrest wings 308 defines a respective side channel 320, and each support wing of the pair of support wings 312 defines a respective support pin 322 slidably movable within the respective side channel 320.

In embodiments, the apparatus 300 may further include a rethread harness system. The rethread harness system may not exert a load on the upper support, such the upper support is non-load bearing.

Children's car seats or apparatuses according to the present disclosure may include a locking feature and corresponding receiving openings for accepting the locking feature. The locking feature may enable the upper support to be locked into either the expanded configuration or the collapsed configuration.

Although not depicted in FIGS. 1 through 7, the upper support may be configured to be rotatable.

Although not depicted in FIGS. 1 through 7, in some embodiments, the children's car seat or apparatus may include a traditional headrest. In some embodiments, the children's car seat or apparatus may include a headrest with an actuator for controlling the upper support. In some embodiments, the children's car seat or apparatus may include a headrest configured for manual adjustment of the upper support. In some embodiments, the children's car seat or apparatus may include a headrest that is inflatable. In some embodiments, the upper support may be detachable and may be manually adjustable and/or installable.

Although not depicted in FIGS. 1 through 7, a user's ability to reduce the overall size of the children's car seat or apparatus may be beneficial for shipping, for storage, for installation benefits, and for a person riding in the driver's seat or the front passenger seat of the automobile, or any other seat in the automobile in front of the seat having the children's car seat disposed on it. Conventional children's car seats may result in reduced front seat leg room due to the bulkiness of conventional children's car seats. The bulkiness is due at least in part because of a compliance requirement that requires a minimum level of coverage for a child disposed within the children's car seat.

When a children's car seat or apparatus according to the present disclosure is in a collapsed configuration, the reduced height of the children's car seat may result in an overall reduced width of the children's car seat since the backrest is disposed at an angle. Thus, when the children's car seat or apparatus is disposed such that it is rear-facing, there is increased ability for the seat in front of the children's car seat to move back, thus increasing passenger leg room for the person sitting in the seat in front of the children's car seat. In some embodiments, the children's car seat or apparatus may enable up to an additional 4 inches of leg room for a front seat. Similarly, when the children's car seat or apparatus is disposed such that it is forward-facing, the reduced height of the children's car seat allows it to avoid any automobile seat structures that may interfere with the children's car seat, such as a vehicle headrest or a C pillar.

Though the disclosed examples include particular arrangements of a number of parts, components, features, and aspects, the disclosure is not limited to only those examples or arrangements shown. Any one or more of the parts, components, features, and aspects of the disclosure may be employed alone or in other arrangements of any two or more of the same.

Although certain product features, functions, components, and parts have been described herein in accordance with the teachings of the present disclosure, the scope of coverage of this patent is not limited thereto. On the contrary, this patent covers all embodiments of the teachings of the disclosure that fairly fall within the scope of permissible equivalents.

Unless otherwise noted, the terms used herein are to be understood according to conventional usage by those of ordinary skill in the relevant art. In addition to the definitions of terms provided below, it is to be understood that as used in the specification and in the claims, “a” or “an” may mean one or more, depending upon the context in which it is used.

Throughout this application, the term “include,” “include(s)” or “including” means “including but not limited to.” Note that certain embodiments may be described relating to a single glass, but the corresponding description should be read to include embodiments of two or more glasses. Different features, variations, and multiple different embodiments are shown and described herein with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by this disclosure. It is indeed intended that the scope of this disclosure should be determined by a proper legal interpretation and construction of the disclosure, including equivalents, as understood by those of skill in the art relying upon the complete disclosure present at the time of filing.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and annexed drawings includes examples of systems, apparatuses, methods, devices, and techniques that, individually and in combination, provide for a convertible children's car seat. It is, of course, not possible to describe every conceivable combination of components and/or methods for purposes of describing the various elements of the disclosure, but it may be recognized that many further combinations and permutations of the disclosed elements are possible. Accordingly, it may be apparent that various modifications may be made to the disclosure without departing from the scope thereof. In addition, or as an alternative, other embodiments of the disclosure may be apparent from consideration of the specification and annexed drawings, and practice of the disclosure as presented herein. It is intended that the examples put forth in the specification and annexed drawings be considered, in all respects, as illustrative and not limiting. Although specific terms are employed herein, they are used in a generic and descriptive sense only and not for purposes of limitation.

What is claimed is:

1. An apparatus for seating a child in a vehicle, the apparatus comprising:
a seat;
a backrest coupled to the seat at an angle; and
an upper support movably coupled to the backrest,
wherein the upper support is configured to move relative to the backrest between an expanded configuration and a collapsed configuration, and
wherein the upper support is not load-bearing.

2. The apparatus of claim 1, further comprising a locking component to lock the upper support in one or both of the expanded configuration or the collapsed configuration.

3. The apparatus of claim 1, wherein the upper support in the expanded configuration extends to a predetermined height vertically beyond the backrest.

4. The apparatus of claim 1, wherein the backrest defines a pair of backrest wings extending from a backrest back, wherein the upper support defines a pair of support wings extending from a support back, and wherein the support wings are aligned with the backrest wings.

5. The apparatus of claim 4, wherein the backrest defines a vertical slot, and wherein the upper support defines a vertical tab movable along the vertical slot.

6. The apparatus of claim 4, wherein each backrest wing of the pair of backrest wings defines a respective side channel, and wherein each support wing of the pair of support wings defines a respective support pin slidably movable within the respective side channel.

7. The apparatus of claim 1, further comprising a rethread harness system.

8. The apparatus of claim 1, wherein the upper support is configured to slide between the expanded configuration and the collapsed configuration.

9. The apparatus of claim 7, wherein respective wings of the upper support are configured to slide along respective wings of the backrest.

10. The apparatus of claim 1, wherein the backrest integrally extends from the seat.

11. An apparatus for seating a child in a vehicle, the apparatus comprising:
a seat;
a backrest coupled to the seat at an angle;
a rethread harness system; and
an upper support coupled to the backrest and slidable relative to the backrest between an expanded configuration and a collapsed configuration,
wherein the upper support is not load-bearing.

12. The apparatus of claim 11, further comprising a locking component to lock the upper support in one or both of the expanded configuration or the collapsed configuration.

13. The apparatus of claim 11, wherein the upper support in the expanded configuration extends to a predetermined height vertically beyond the backrest.

14. The apparatus of claim 11, wherein the backrest defines a pair of backrest wings extending from a backrest back, wherein the upper support defines a pair of support wings extending from the support back, and wherein the support wings are aligned with the backrest wings.

15. The apparatus of claim 14, wherein the backrest defines a vertical slot, wherein the upper support defines a vertical tab movable along the vertical slot, wherein each backrest wing of the pair of backrest wings defines a respective side channel, and wherein each support wing of the pair of support wings defines a respective support pin slidably movable within the respective side channel.

17. A method of adjusting a children's car seat, comprising:
removing a locking component from a first receiving loop;
sliding a non-load bearing upper support along a backrest of the children's car seat; and
inserting the locking component into a second receiving loop.

18. The method of claim 17, wherein the sliding comprises sliding a vertical tab of the upper support along a vertical slot of the backrest.

19. The method of claim 17, wherein the sliding comprises sliding respective support wings of the upper support along respective backrest wings of the backrest.

20. The method of claim 17, wherein sliding the upper support along the backrest increases or decreases a height of the children's car seat.
